(19) United States
(12) Patent Application Publication
(10) Pub. No.: US 2007/0061190 A1
(43) Pub. Date: Mar. 15, 2007

(54) Multichannel tiered profile marketing method and apparatus

(76) Inventor: Keith Wardell, Fairfax Station, VA (US)

Correspondence Address: Brian L. Michaelis;Brown Rudnick Berlack Israels LLP, One Financial Center, Box IP, Boston, MA, 02111, US

(21) Appl. No.: 11/499,516

(22) Filed: Aug. 4, 2006

Related U.S. Application Data
(63) Continuation-in-part of application No. 10/933,082, filed on Sep. 2, 2004.

(51) Int. Cl. G06F 17/30

(52) U.S. Cl. 705/10

(57) ABSTRACT

A method for optimizing a marketing campaign is provided. Initially, an analysis of a client's transaction data is performed. Campaign objectives are selected based upon the findings of this analysis. Rules are selected for each campaign based upon the rules' ability to achieve the selected objectives. Based on the rules, personalized communications are delivered to achieve the client's objectives.

### RELATED APPLICATIONS

This application is a continuation-in-part of U.S. patent application Ser. No. 10/933,082, entitled Method for Optimizing a Marketing Campaign, and filed Sep. 2, 2004, which is incorporated herein by reference in its entirety.

### TECHNICAL FIELD

The present disclosure relates generally to marketing applications, and more particularly to systems and methods for implementing marketing campaigns.

### BACKGROUND OF THE INVENTION

The Internet is making dramatic changes in the way companies market to their customers. This channel for communicating with customers offers tremendous opportunity for companies that master its use. While every company has begun to experiment with the Internet, few have truly realized its potential. The Internet offers the potential for more meaningful and cost-effective communications with existing and potential customers. However, to truly achieve this potential, companies must change the way they view their marketing communications. To date, most companies have failed to make the changes necessary to capture the true potential of the Internet.

What is necessary to achieve the full potential of the Internet is to change the view of marketing from “company-centric” marketing to “consumer-centric” marketing. Traditionally, offline marketing channels have forced marketers to be company-centric. In these channels, the company defines the products to advertise over television, radio, print and other traditional media. The message, while tailored to the target audience, is the same for all consumers. Changes in the message may increase the appeal among one group of consumers, but often at the expense of another. Marketers spend a lot of money trying to develop the optimal message. Similarly, retailers develop one store layout designed to appeal to as many potential customers as possible. Direct mail and catalog offers are essentially the same, but only focus on those customers who fit a specific profile. In each case, the company makes the decision about the offer and delivers it to a mass audience.

The Internet offers a different approach. The online environment offers marketers the opportunity to make the transition from being company-centric to becoming consumer-centric. As a consumer-centric marketer, companies can develop offers based upon their interaction and purchasing history with each individual consumer. Done correctly, consumer-centric marketing enables the company to increase their relevance to each consumer without the potential for diluting their relevance with other consumers. For example, Internet marketers have the capability at hand to design their web sites and their email offers to appeal to each individual customer. However, to make this transition requires changing the way a company views marketing. Traditionally, companies have managed products and so ask questions like “which products are shown on TV or advertised on radio?; which products are displayed in the store or included in the catalog?; and what will be the hot new product that will appeal to the largest audience? As such, offline channels have required companies to manage products, not customers.

Despite the fact that the online channel offers the potential to move from managing products to managing customers, presently there are few, if any, effective facilities to realize such opportunities. Known technologies do not effectively use the transaction and browsing history of each customer to tailor the methods, timing and content of their communications with that customer.

In addition, the Internet has taught customers that their communications can be personalized and to expect that companies will address them as individuals. The Internet has also brought about a second major change that requires a change in the way companies interact with their customers: the Internet has added a multi-channel component to every company and forced marketers to coordinate their communications across each channel. The complexity of creating personalized communications is compounded by the need to do so across multiple channels. This has put pressure on every marketing department.

The solution requires an approach that can personalize the customer experience across all marketing channels. Traditional marketing begins with the product; considers how the product should be merchandised; then marketing concepts are determined with the goal, finally, to attract customers. This process does not allow for personalized offers to customers. In addition, which channels a customer might prefer is not considered. A more innovative approach is necessary to address the current need for personalization especially as relates to multi-channel marketing. The advance of the Internet, the diversity of choices available to consumers and the fragmentation of many media has made it an imperative to personalize communications to customers across all sales channels.

### SUMMARY OF THE INVENTION

The present invention provides methods and apparatus for helping companies make the transition from company-centric marketing to consumer-centric marketing, and shifts the approach from managing products to managing customers. The invention addresses the need for personalization in the context of multi-channel marketing for helping companies begin with the customer and develop the marketing approach, in multiple channels, based upon customer interaction and purchasing history. Merchandising and product selection follow based upon transaction and the individual customer's preferences.

According to the present invention the problems associated with prior art marketing applications are solved by providing a multi-client, rules-based method and apparatus which uses customer transaction and clients'/subscribers' historical sales data to determine the most effective marketing offers. A brand personalization marketing model delivers campaigns using rules-based analytics on demand for clients/subscribers. The model is not limited to subscriber-specific data, but rather uses results across all participating subscribers.

The system and method of the present disclosures allows clients to personalize their marketing incentives and offers, by delivering certain products and/or prices to individuals most likely to purchase targeted products and services. Transaction data is analyzed and findings are output from the analysis. Based on the findings, marketing objectives are identified, and rules are determined which are most likely to accomplish these objectives. Based on these rules, the model delivers offers and incentives most likely to influence individual customer behavior.

The system and method also allows marketers to look at their customers using a Tiered Profile that provides the relevant insight for each marketing communication. In addition, a process for developing Personalization Rules that can be applied across all sales channels is provided. The system and method provides techniques and affiliations to execute relevant marketing campaigns across all sales channels. The combination of the rules-based approach with the ability to deliver offers across multiple channels offers an easy solution for becoming true customer-centric marketers.

In one particular embodiment, a method of optimizing a marketing campaign is provided, in accordance with the principles of the present disclosure. The method includes the steps of extracting a subscriber's historical transaction data from both online and offline channels; performing multiple inductive data analyses; selecting objectives for subscribers to use in website, email, print, call center and wireless marketing campaigns; and delivering to each customer pre-determined offers according to rules based upon their individual transaction and click stream behavior. These rules are based upon results identified across all subscribers to identify key relationships between subscriber marketing objectives, campaign rules, and successful outcomes.

Companies that are successful at mastering these communications are able to make their communication more relevant to each individual customer without affecting their relationships with other customers. In doing this, the company becomes more relevant to more customers.

The approach described herein results in marketing campaigns that contain more relevant offers for each customer. This results in higher customer satisfaction, increased customer retention and higher sales per customer. The approach combines the science of data-driven offers with the art of judgment provided by the subscriber at each critical stage. The result is a program more likely to meet subscriber objectives and deliver meaningful communications to the subscriber's customers.

### BRIEF DESCRIPTION OF THE DRAWINGS

The foregoing features and advantages of the present invention will be understood by reference to the following description, taken in connection with the accompanying drawings, in which:

FIG. 1A is a block diagram of the brand personalization marketing model in accordance with the principles of the present disclosure;

FIG. 1B is an illustration of the relationship between findings, objectives, and rules;

FIG. 1C is an illustration of the relationship between a tiered profile, campaigns and objectives, and personalization rules;

FIG. 2 is a diagram of an analysis module included in the model illustrated in FIG. 1A;

FIGS. 3A and 3B are illustrations of value analyses performed during the analysis module;

FIGS. 4A and 4B are illustrations of stage analyses performed during the analysis module;

FIGS. 5A and 5B are illustrations of merchandising analyses performed during the analysis module;

FIGS. 6A and 6B are product affinity analyses performed during the analysis module;

FIG. 6C is an illustration of a tiered profile developed during the analysis module;

FIG. 6D is an illustration of a relationship map identifying communications planned in a specified time frame;

FIG. 7 is a diagram of an objectives module included in the model illustrated in FIG. 1A;

FIG. 8 is a diagram of a rules module included in the model illustrated in FIG. 1A;

FIG. 9 is a campaign plan generated during the rules module illustrated in FIG. 8;

FIG. 10 is a diagram of a delivery module included in the model illustrated in FIG. 1A;

FIG. 11 is an illustration of template development performed during the delivery module illustrated in FIG. 10;

FIG. 12 is an illustration of an email matrix used in the delivery module illustrated in FIG. 10;

FIG. 13A is an overview of multi-channel applications of the model illustrated in FIG. 1A;

FIG. 13B is a view of an email campaign executed during the multi-channel applications illustrated in FIG. 13A;

FIG. 13C is an illustration of a website campaign in connection with the applications illustrated in FIG. 13A;

FIG. 13D illustrates a print campaign in connection with the applications illustrated in FIG. 13A;

FIG. 13E illustrates a call center campaign in connection with the applications illustrated in FIG. 13A;

FIG. 13F illustrates a store campaign in connection with the applications illustrated in FIG. 13A; and

FIG. 13G illustrates a media campaign in connection with the applications illustrated in FIG. 13A.

### DETAILED DESCRIPTION

An illustrative embodiment of the marketing optimization method and apparatus disclosed is first discussed in terms of a method of optimizing an email marketing campaign. The presently disclosed method includes analyzing a client's customer transaction data, identifying marketing objectives based on the findings of the analysis, selecting marketing rules based upon the objectives, and delivering personalized emails reflective of each customer's unique purchasing behavior. However, it is contemplated that the optimization method may also be used to deliver web site, call center, or wireless campaigns.

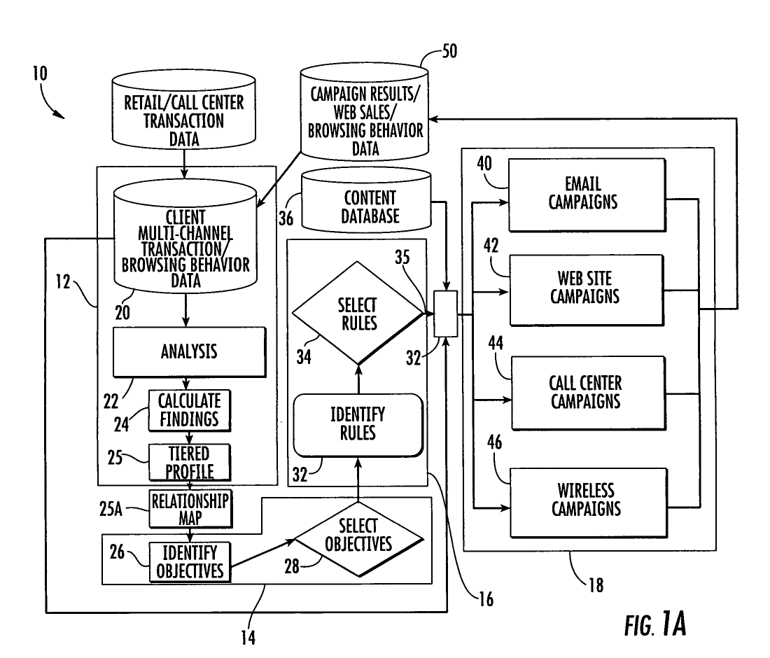

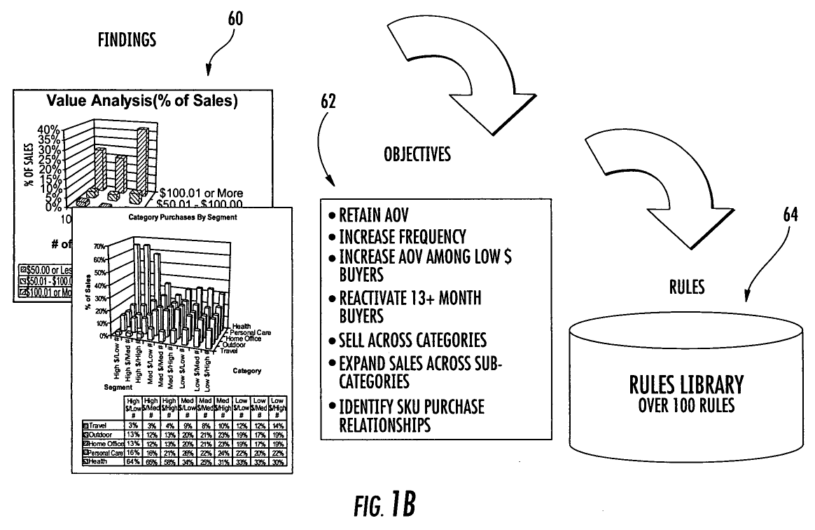

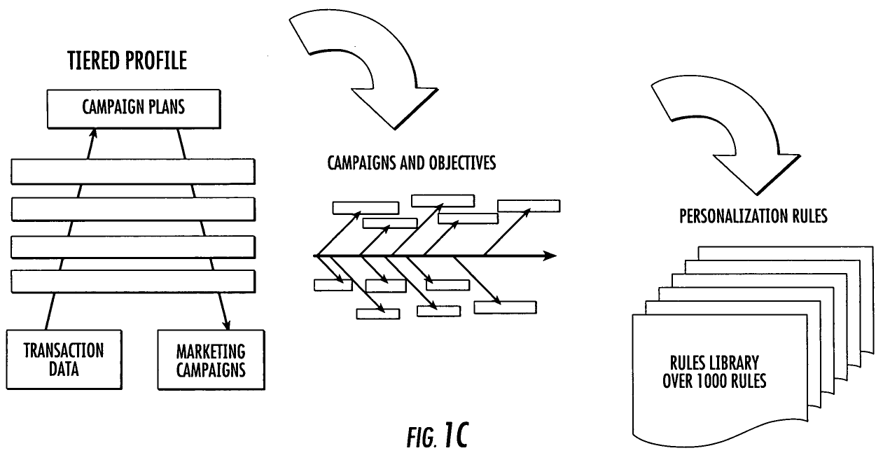

Referring now to FIG. 1A, there is illustrated an overview of a method for optimizing an email marketing campaign, constructed in accordance with the principles of the present disclosure, and referred to specifically as a “brand personalization” model 10. An analysis module 12 is used to identify strengths and weaknesses in the ways that customers interact with the client's/company's brand and offerings. In Step 20, the client provides, for example, two years of multi-channel transaction/browsing behavior data (“transaction data”). This transaction data includes data about customers from both online sales channels such as websites, and offline sales channels such as retail, call centers, and catalogs. The transaction data may include—in the case of an online channel—the clickstream information, purchase/sales data, zip codes and addresses, or other data “left behind” by customers at a client's website.

The transaction data is housed for each client and each of their individual customers in the Client Multi-Channel Transaction/Browsing Database, Step 20. This data is used in the analysis and later in determining which offer each individual customer will receive, as described in greater detail hereinafter. The data includes every transaction at the line item level (i.e. full data on each item purchased in a transaction). For example, the database includes line-item data for each transaction and for every transaction the database may include the following data: product name, SKU, customer name, purchase price, purchase date, and specific product characteristics (i.e color, size, etc . . . ).

The transaction data is analyzed, step 22, to determine the unique characteristics of the client's customers. These measures include, for example, recency, order frequency, average order amount/value, value contribution, relationship stage, and product purchasing patterns at the category, sub-category and SKU level. The findings of these analyses are calculated in Step 24 and guide the identification of characteristics that can be used to personalize customer communications. These findings can include the percent of customers purchasing one, two and three or more times; the percent of customers purchasing within the past six months, seven to twelve months and thirteen or more months; the percentage of customers purchasing from each product category; and the percentage of customers purchasing in one product category that also purchased another product category.

In Step 25, the transaction data is clustered to develop a “tiered profile” that provides insight for the communications. The clustering for developing the tiered profile is described hereinafter.

In Step 25A, a relationship map is developed to identify all of the types of communications planned during a specified time frame.

In an objectives module 14 objectives are identified, step 26, that relate to the findings from the analysis. For example, a finding of “low purchase frequency” might indicate an objective to “increase purchase frequency.” Or, a finding of “below average purchasing across categories” would lead to an objective to “increase sales across categories.” In Step 28, the client selects from the set of recommended objectives those most aligned with their online marketing goals. The selection of objectives may be a manual step, i.e., performed by a human, or automated as a function of a computer process.

A rules module 16 includes a rules identification step 32 that identifies potential marketing and merchandising rules, based on the selected objectives. For example, to “increase purchase frequency,” a multi-brand segmentation rule might be applied. In step 34, the client selects from the recommended set of rules a final campaign rule or rules 35 most likely to accomplish the selected objectives.

Once the final campaign rule is selected, the model returns to the Client Multi-Channel Transaction/Browsing Data, Step 20, and applies the selected rule to each individual customer of the client in question, in a rule processing step 37. For example, a rule may call for customers to receive advertising for products with a high affinity to their most recent purchase. If a client has one million customers, each of their most recent transactions is identified and the appropriate products determined for them to receive targeted advertisements.

In any of Steps 40, 42, 44, 46 of a delivery module 18, an email, website, call center or wireless campaign is delivered, based on the final campaign rules. In the case of an email campaign 40, personalized emails along with relevant product offers are sent to each customer. The content inserted in the emails are stored and retrieved from a content database 36. Campaigns directed to other sales channels such as print, store, and media channels can also be delivered.

Accordingly, in view of the above-described relationship amongst findings 60, objectives 62 and rules 64 as depicted in FIGS. 1A and 1B, the brand personalization model 10 enables delivery of products or messages to the client's customers based on, among other things, each customer's individual transaction history. More specifically, in FIG. 1B, the findings 60 are calculated based upon an analysis of the client's transaction history. From these findings 60, a set of marketing and merchandising objectives 62 are recommended and the client selects those most important to their business. Once the objectives 62 are selected, rules 64 are recommended (from a flexible and extensible library of rules) based upon their proven ability to successfully accomplish the selected objectives 62.

As illustrated generally in FIG. 1C, the Tiered Profile identifies the different segments of customers and three separate levels. Using one of these levels, a company can then identify which campaigns each segment should receive. Finally, Once the campaigns have been defined, the personalization rule for each campaign can be selected.

In Step 50 of FIG. 1A, the Campaign results, web sales, and browsing behavior data are tracked and reported. For example, all click activity is tracked and retained at an individual customer level, and sales activity at the client's website is tracked for complete performance analysis. In addition, the relationships between findings, objectives and rules 60, 62, 64 are validated or revised to further improve the model 10. For example, clients can track their progress towards the selected objectives and make modifications thereto as required. In this way, the brand personalization model 10 adapts to changing relationships between findings, objectives and rules 60, 62, 64, so as to optimize delivery of campaign 40.

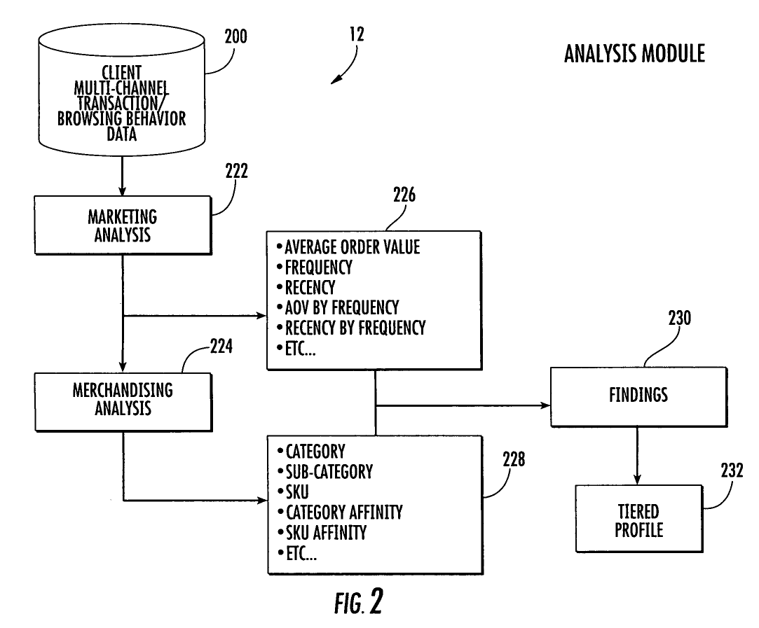

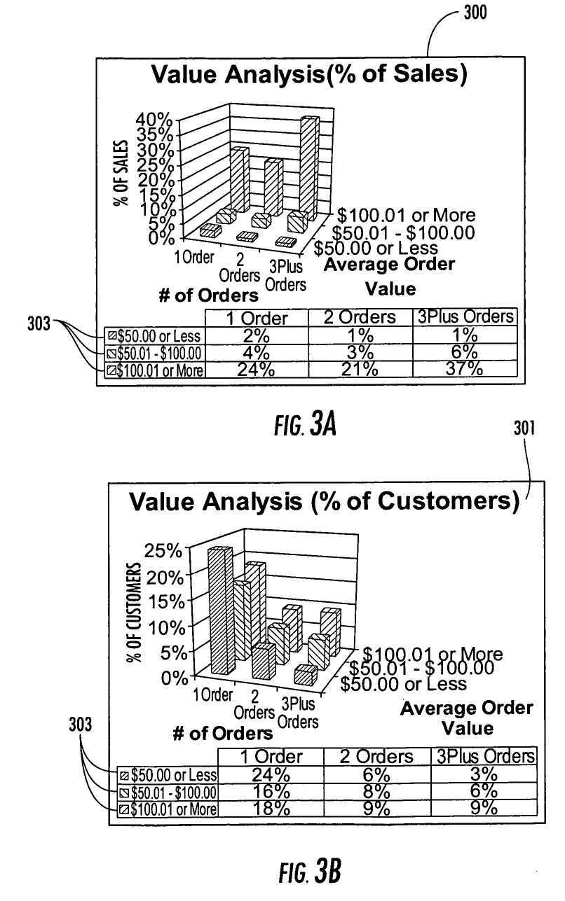

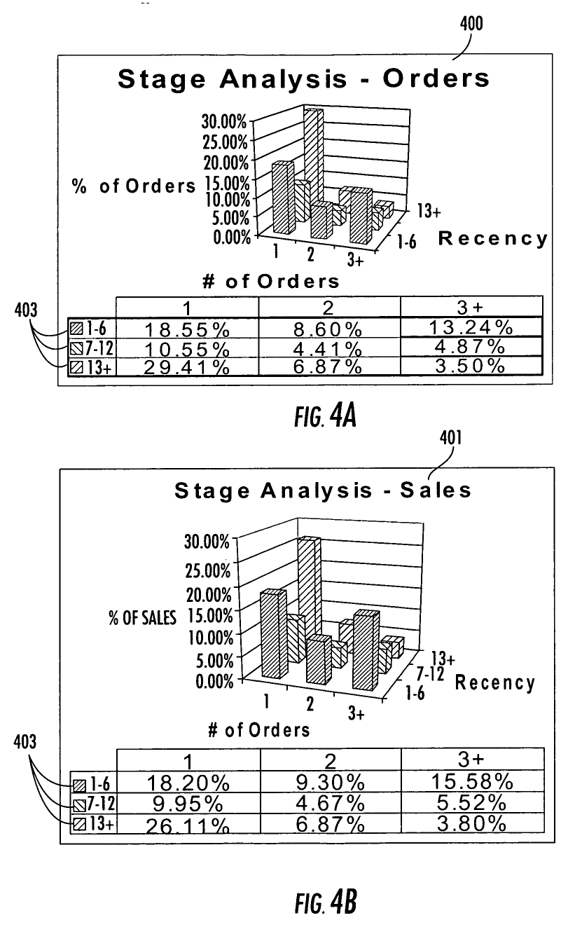

FIG. 2 illustrates the analysis module 12 of FIG. 1A in greater detail. In Step 200, the client transaction data/customer transaction file is provided. In Step 222, marketing analyses of the transaction data are conducted based upon well-known measures 226 including recency, frequency and average order value (“AOV”). For example, in FIGS. 3A and 3B, the value analyses 300, 301 look at the interaction of order frequency and average order value. These measures identify the most valuable segments of the customer base, and also those segments requiring improvement.

Illustratively, by comparing the “percent of orders” to the “percent of sales” as illustrated in FIG. 3B, each customer segment 303 can be assigned a relative value such as low, medium, or high AOV. Based on this analysis, in FIG. 2 Step 230 calculates a “Marketing Finding” that “36% of customers spend over $100 per order and account for 82% of sales.” This finding not only shows the importance of the high AOV segment, but suggests an objective of “increasing the percentage of high AOV customers.” Step 230 also calculates a finding that “33% of customers spending under $50 per order account for only 6% of sales,” which indicates an objectives of “changing pricing,” and “review new customer sources.”

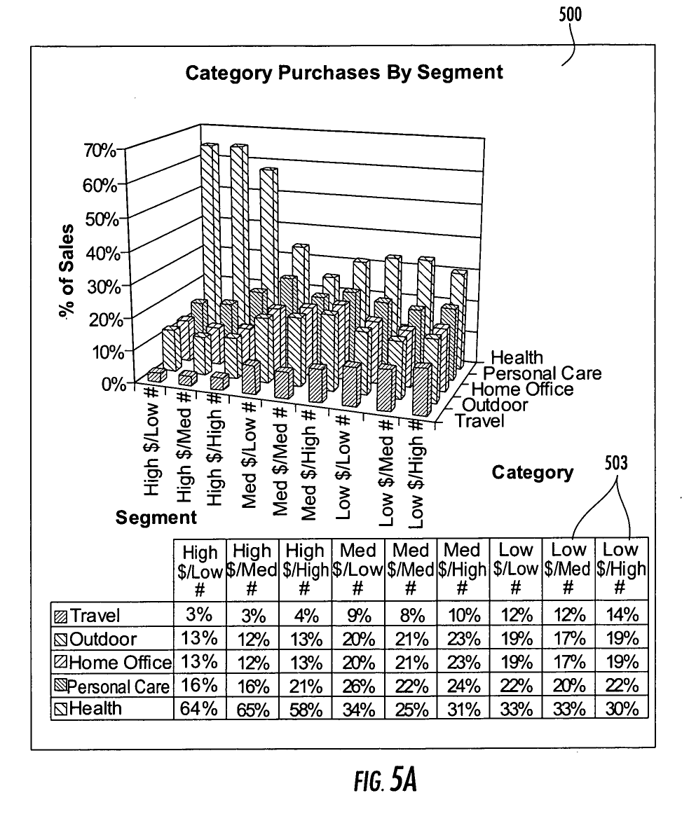

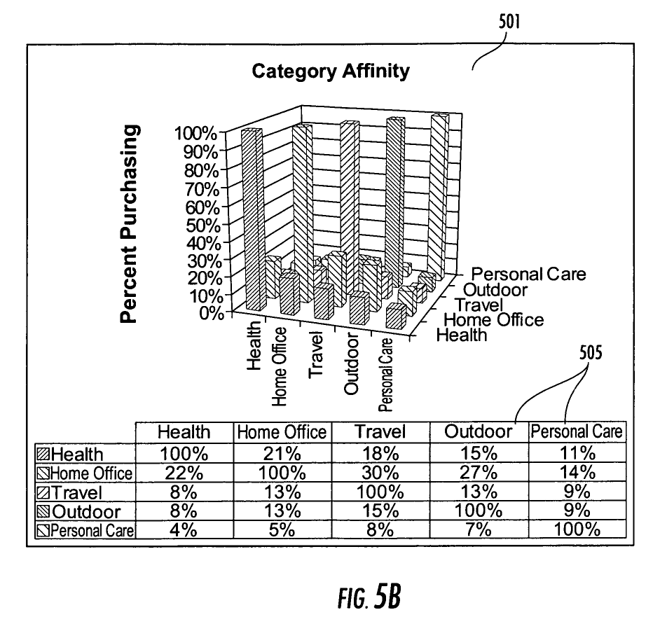

In a further illustration of calculating findings from transaction data analysis, FIGS. 4A and 4B illustrate stage analyses 400, 401 that look at the relationship between recency and order frequency. These analyses identify key events/stages 403 in the customer relationship that could drive specific offers. Based on analyses 400, 401, Step 230 calculates a finding that “multi-buyers have high percentage buying in the past twelve months.” Another finding might be “37% of sales are from customers who have not purchased for over 12 months.” Thus, by analyzing buyer behavior through a life cycle of first-time buyer to multi-buyer to long-term customer, opportunities to improve customer value are identified.

In Step 224 (FIG. 2), “merchandising analyses” of the transaction data are performed. These analyze customer segments for product purchase behavior based upon measures 228 such as product category, sub-category and SKU, or product affinity amongst category, sub-category and SKU. For example, FIG. 5A illustrates a product category analysis 500, which shows product category purchasing behavior across customer segments 503. FIG. 5B illustrates a category affinity analysis 501 used in identifying opportunities for increasing sales by selling across categories 505. Based on such analysis 501, substep 230 calculates a merchandising finding of “a low level of purchasing across categories, with the highest level being 30% between Travel and Home Office, while most categories demonstrate less than 20% of customers buying from both categories.” This finding can be used later to develop relevant merchandising objectives.

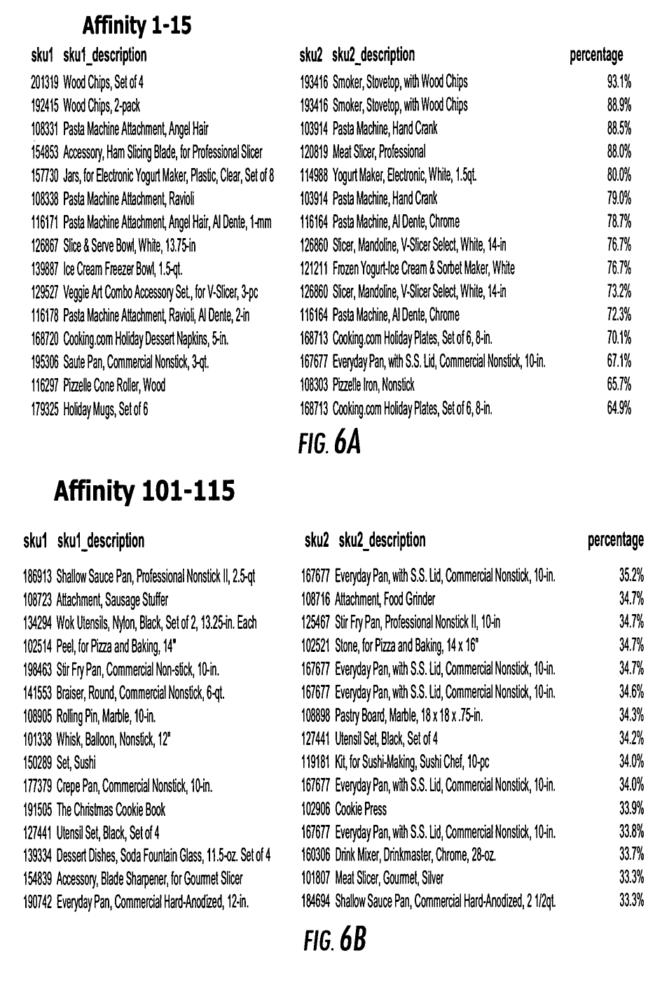

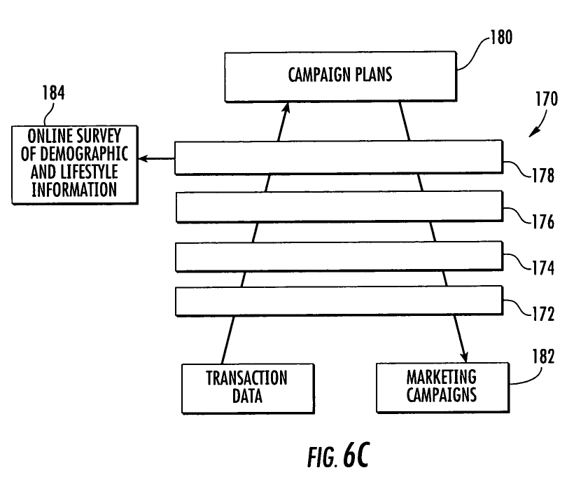

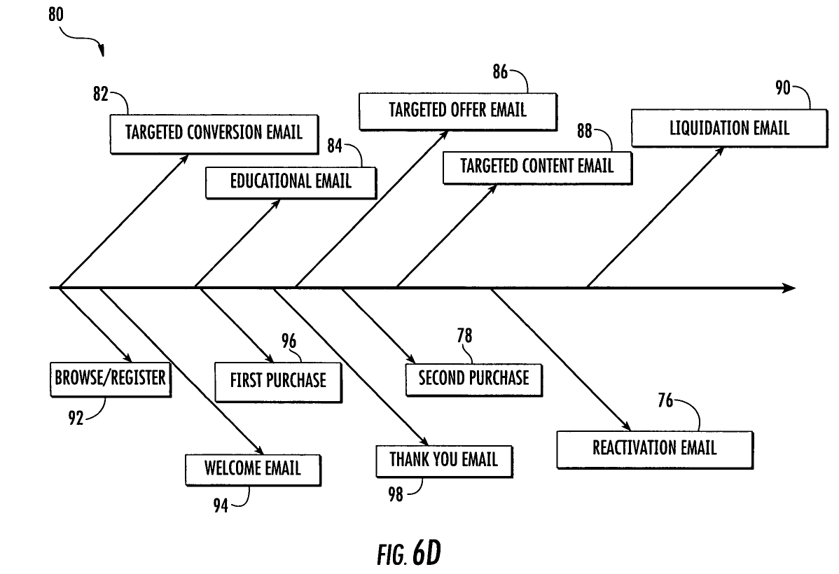

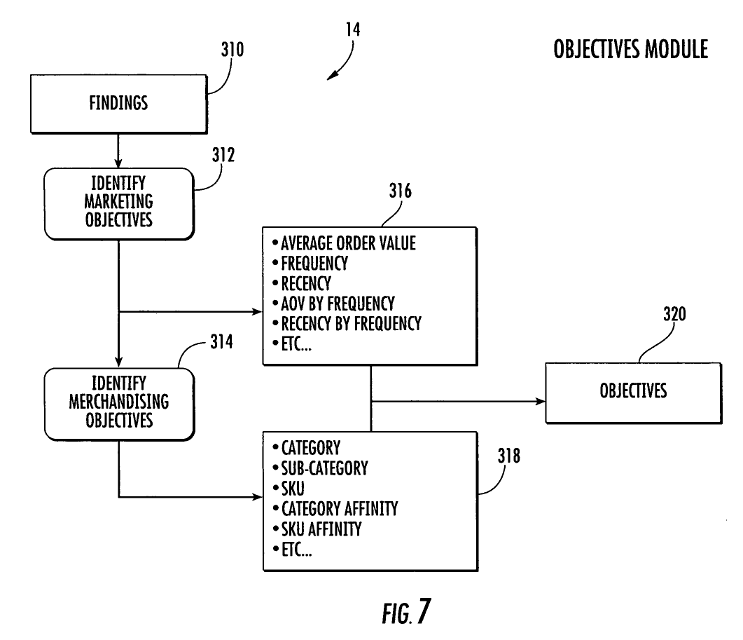

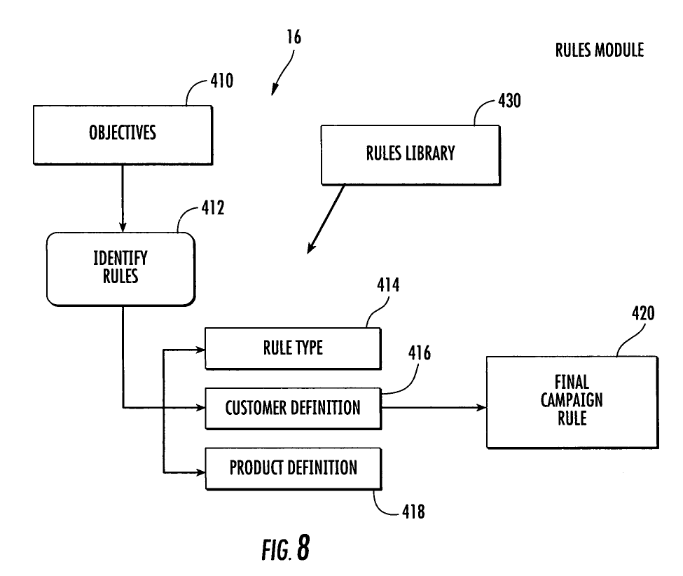

FIGS. 6A and 6B illustrate a product affinity analysis 600 that looks at pairs of products with the highest affinity, to identify specific cross-sell opportunities at the SKU level. The top 15 pairs in this example are shown in FIG. 6A, which illustrates that a high percentage of customers who purchased SKU1 also purchased SKU2. Looking left to right in FIG. 6A, it is evident that these products belong together and likely were purchased together. However, when looking from top to bottom of FIG. 6A, it is evident that customers purchased a wide variety of product combinations. This observation leads to calculation in Step 230 of a merchandising finding of “strong differentiation at the product level.”

When looking at the 101^{st} to 115^{th} product affinity pairs, a similar pattern is seen between SKU1 and SKU2. These products have obviously been merchandised to go together. Looking from top to bottom in the chart, the diversity of products is also evident. The difference here is that only about 35% of customers who purchased SKU1 have purchased SKU2. This demonstrates a finding of “strong potential for additional sales to purchasers of SKU1.” Other examples of marketing findings and merchandising finding are listed in TABLE 1.

TABLE 1

| Marketing Findings | Merchandising Finding |
|---|---|
| Low purchase frequency with one time buyers at | Product purchase behavior shows |
| 78%. | greater variance as the analysis |
| Since AOV varies significantly, price will play an | moves from category to class. |
| important role. | Company shows a high level of |
| 12% of customers spending $150 or more | variability across product categories |
| account for 38% of sales. | with highest variation in Health or |
| 71% of orders account for 34% of sales. | Personal Care. |
| Multi-buyers have high percentage buying | Product level affinity should |
| in the past 12 months. | demonstrate the best opportunity for |
| 37% of sales are from customers who | using merchandising to increase |
| have not purchased for over 12 months. | frequency. |
| Percent One Time Buyers | Top brands have broad appeal. |
| Percent Three or More Time Buyers | Category Sales Highest Deviation |
| AOV at 25% | Category Sales Lowest Deviation |
| AOV at 90% | Category Sales High/Low Ratio |
| AOV Ratio | Category Affinity Highest Percent |
| % of Buyers 0-6 Months | Category Affinity Lowest Percent |
| % of Buyers 13+ Months | Category Affinity Average Percent |
| Sales to Order Ratio Low Freq/Low AOV | Sub-Category Low/Low — |
| Sales to Order Ratio High Freq/High | High/High Top 10 Overlap |
| AOV | Sub-Category Sales Ratio 1 to 20 |
| Sales to Order Ratio Low Freq/0-6 | Product Affinity Top 15 Average |
| months | Product Affinity 101-115 Average |
| Sales to Order Ratio High Freq/0-6 | Product Affinity Ratio |
| months | |
| Sales to Order Ratio Low Freq/13+ | |
| months | |
| Sales to Order Ratio High Freq/13+ | |
| months | |

In Step 232 of FIG. 2, the transaction data is clustered to develop a tiered profile 170 for use in developing campaign plans 180. As shown in FIG. 6C, an illustrative tiered profile 170 has four levels beginning with individual customer data 172 as the foundation. The next level of the profile 170 provides between approximately 60 and 200 sub-segments 174. The third tier aggregates these sub-segments 174 to approximately 30 to 40 segments 176. Finally, a set of approximately 6 to 12 “personas” 178 are aggregated from the segments 176.

These segments are created using two years of prior transaction data. A proprietary clustering approach is employed, which allows the creation of multiple cluster versions or tiers, that are defined at varying levels of specificity, but are related to each other. This way, knowing which segment a customer assigned in one tier, his segment in the other tiers can be determined. This method allows for the use of different tiers for different marketing campaigns, while allowing the analysis to consistent across all campaigns, regardless of channel.

This tiered profile 170 allows companies to look at their customers at various levels, while still working with one profile. These levels provide the flexibility to conduct marketing campaigns 182 across all of the company's sales channels in an effective manner.

Once the profile 170 is developed based upon transaction data, surveys 184 can be conducted to better identify the lifestyle and demographic characteristics of the personas 178. This information will provide the basis for developing creative campaigns that will appeal specifically to each persona 178. In addition, these surveys 184 might identify media usage and store shopping preferences.

Using a tiered profile 170 allows marketers to address several marketing applications with the same profile as illustrated in TABLE 1A. For example, a higher level (more aggregated) tier can be used for copy development or retail store analysis, while a lower level (more detailed) tier can be used to target email campaigns. These response to these campaigns can be analyzed using any level of the tiered profile, making multi-channel analysis possible. Current applications use different targeting methods for different channels, which cannot be related (i.e. gender for direct mail creative copy and shopping recency for store promotions).

TABLE 1A

| Profile Level | Applications Addressed |
|---|---|
| Persona | Creative; Advertising |
| Segments | Marketing; Merchandising |
| Sub-Segments | Promotion; Targeting |
| Individual Data | Direct Marketing; Event-Based Programs |

In addition, the tiered profile 170 is more effective for working across multiple sales channels as illustrated in TABLE 1B.

TABLE 1B

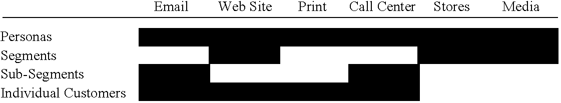

As can be seen in TABLE 1B, the personas 178 offer the opportunity to coordinate creative development across all marketing channels to provide the company with a consistent communications approach. In addition, stores can be profiled by personas 178 to better understand purchasing patterns. Finally, the media usage of each persona 178 is likely to be different. The appropriate creative and media behavior can be identified for each persona 178. For example, a persona 178 that may be young, single and live in cities will have different radio, magazine, cable and event based usage than a persona 178 of young couples with children living in the suburbs.

The segment level 176 of the profile (about 30 segments) allows marketers and merchandisers to see the differences among customers and address them in their product selection and marketing programs. The web site, store and media channels may be in the best position to use this level of profile. The determination of the level of profile to be used is based upon the marketers ability to execute based on a certain number of segments. For example, marketing and merchandising would use the segment level (about 30 segments) because this is enough to find the differences in customer product preference, where the six personas would not uncover these differences. At the same time, using the 100 sub-segment would require too many tailored marketing and merchandising plans.

The sub-segment level 174 of the profile begins to provide a more granular look at a company's customers. Typically 60 to 200 sub-segments 174, the goal is less to understand each sub-segment than to use them to make specific product or marketing offers based upon their prior purchase behavior. This level of the profile allows many of the benefits of individual data 172 in a more manageable format (see clustering description above).

Finally, many of the sales channels can take advantage of individual data 172 to make their communications more relevant. Email, web sites, print and call centers all have the opportunity to make specific offers to individuals based upon their prior purchase behavior. This 1 to 1 level of the profile also makes offers based upon individual customer activities possible. If a customer visits a web site, it is then possible to send them a message the next day targeted to the product or category they browsed. Similarly, this information could be used across channels to make-a special offer if the customer contacts the call center after visiting the site.

FIG. 6D illustrates a relationship map 80 in more detail. The relationship map 80 is developed to identify all of the types of communications (“campaigns”) planned during a specified time frame. This map is developed following the initial customer analysis and prior to determining the personalization rules, since these are campaign specific. This time frame can be a quarter, a year or longer. The types of campaigns can include, among others, targeted conversion email 82, educational email 84, targeted offer email 86, targeted content email 88, liquidation email 90, browse/register 92, welcome email 94, first purchase 96, thank you email 98, second purchase 78 or reactivation email 76. As can be seen in FIG. 6D, each endpoint along the map 80 defines a campaign.

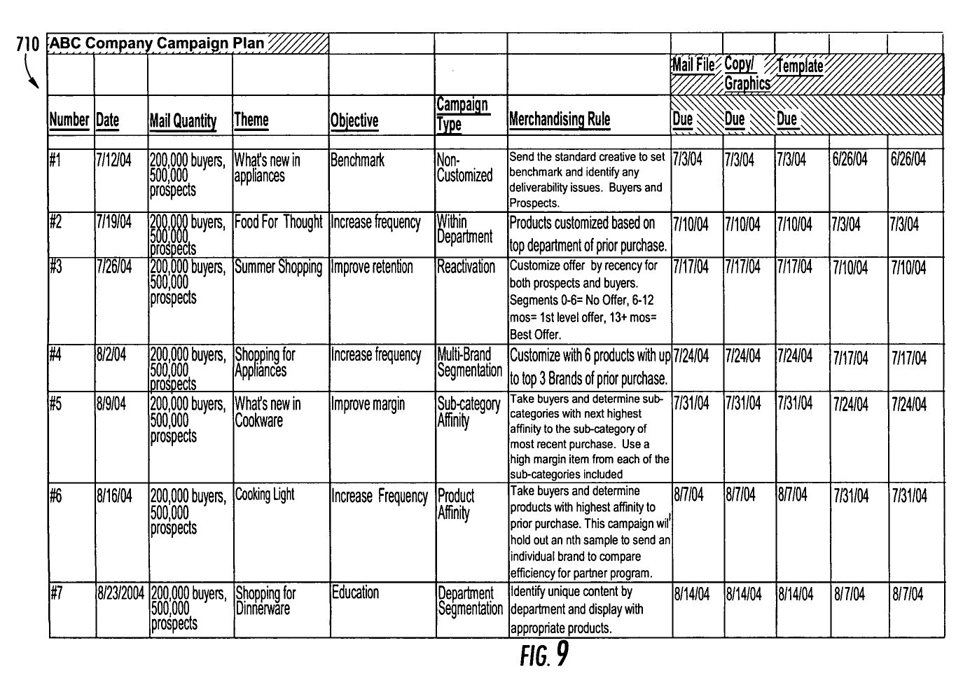

FIG. 7 illustrates the objectives module 14 in more detail. Based on marketing findings 310, corresponding marketing objectives are identified, 312. These objectives are expressed in terms of transaction parameters 316, for example, average order value, frequency, recency, AOV by frequency, and recency by frequency. Marketing objectives most aligned with the client's goals are selected from the set of recommended objectives, 320. The relationship between typical marketing objectives and their corresponding marketing findings is illustrated in TABLE 2.

TABLE 2

| Marketing Findings | Marketing Objectives |
|---|---|
| Low purchase frequency with one time buyers at | Increase order |
| 78%. | frequency |
| Since AOV varies significantly, price will play an | Increase percentage |
| important role; | of high AOV buyers |
| 12% of customers spending $150 or more account | |
| for 38% of sales; and | |
| 71% of orders account for 34% of sales. | |
| Multi-buyers have high percentage buying in the | Reward multi-buyers |
| past 12 months | |
| About 37% of sales are from customers who have | Reactivate 13+ |
| not purchased for over 12 months | month buyers |

Merchandising objectives in merchandise terms 318 of, for example, category, sub-category, SKU, category affinity and SKU affinity are then identified, 314. Then merchandising objectives most aligned with the client's goals are selected from the set of recommended objectives, 320. Examples of merchandising objectives as they correspond to merchandising findings 310 are summarized in TABLE 3.

TABLE 3

| | Merchandising |
|---|---|
| Merchandising Findings | Objectives |
| Product purchase behavior shows greater variance | Use SKUs with high |
| as the analysis moves from category to class. | correlation to address |
| | one time buyers |
| Company shows a high level of variability across | Focus on selling |
| product categories. Highest variation in Health | across categories |
| and Personal Care. | |
| Product level affinity should demonstrate the best | Focus on selling |
| opportunity for using merchandising to increase | within sub-categories |
| frequency. | |
| Top brands have broad appeal | Feature higher priced |
| | merchandise in email |
| | to buyers |

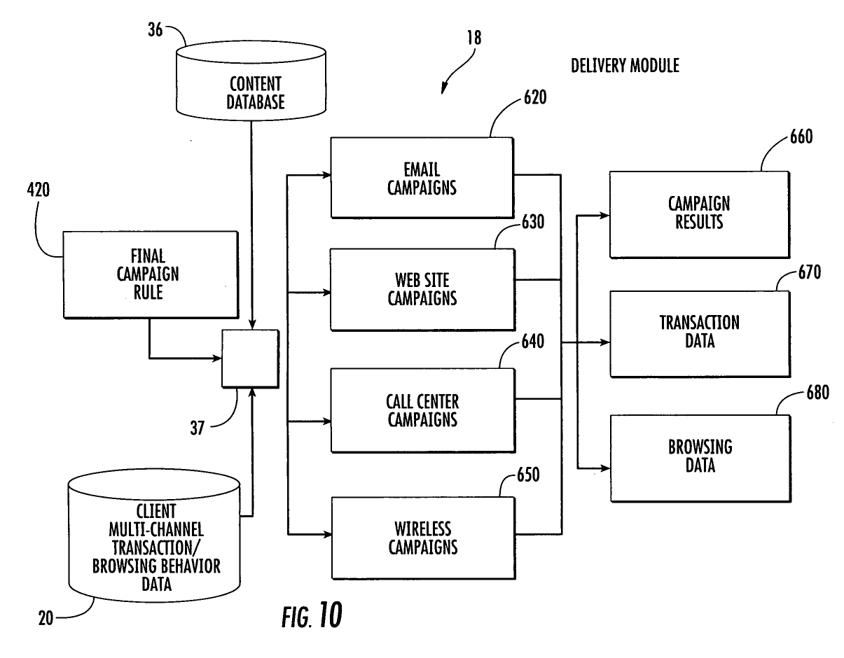

FIG. 8 illustrates the rules module 16 of FIG. 1A in more detail. In this connection, a large library 430 of marketing and merchandising rules is implemented for use in email and web site campaigns. Campaign rules are identified in Step 412 that relate to objectives 410. Each rule has a plurality of variable data elements/components. In this illustrative embodiment each rule has three variable data elements. By adjusting the components in the rules, thousands of unique rules can be generated. In this way, rules are determined 412 which are used to guide the client in accomplishing their objectives 410. That is, based on the selected list of objectives 410, the appropriate rules to be used in each campaign are determined. For example, to achieve an objective 410 of “increasing purchase frequency,” a so-called multi-brand segmentation rule might be applied. In another example, to accomplish an objective 410 of “increasing sales across categories,” a “category affinity” rule might work.

A first rule component, or rule type, is selected in Step 414. The type of rule defines the statistical treatment of the transaction data. Examples of rule types include simple segmentation, complex segmentation, product affinity, or replenishment. A second component, customer definition, is selected in Step 416. Customer definition defines the way(s) buyers are classified. Examples include SKU of most recent purchase, amount of most recent purchase, and most purchased category. A third component, product definition, is determined in step 418, and defines the method for selecting products. Examples of product definition include best sellers, new products, seasonal products, and best sellers by category. Additional examples of the three rule components appear in TABLE 4.

TABLE 4

| Rule Type | Customer Definition | Product Definition |
|---|---|---|
| Category | Most Recent Purchase | Overall Best Sellers |
| Multi-Category | Highest Total Amount | Category Best Sellers |
| Category Affinity | Highest Total Units | Seasonal Items |
| Product Affinity | Highest Price | New Products |
| Reactivation | Date of Most Recent Purchase | Price Point |
| Replenishment | Number of Purchases | Brand |
| Sales Add-On | Average Order Value | Overstocks |
| Event Driven | | High Margin |
| Educational | | |
| Liquidation | | |
| Click Stream | | |
| Multi-Channel | | |

Based on the selection of a rule type, customer definition, and product definition, a final campaign rule is determined in Step 420. For example, if the rule type, customer definition, and product definition selected are, respectively, category affinity, highest total units, and new products, then one final campaign rule might be:

“The campaign will be a category affinity based upon an analysis calculating cross category potential. The buyer's category will be selected based upon the category from which they have purchased the most units. They will receive two new products each from the category they purchased and the two highest affinity categories.”

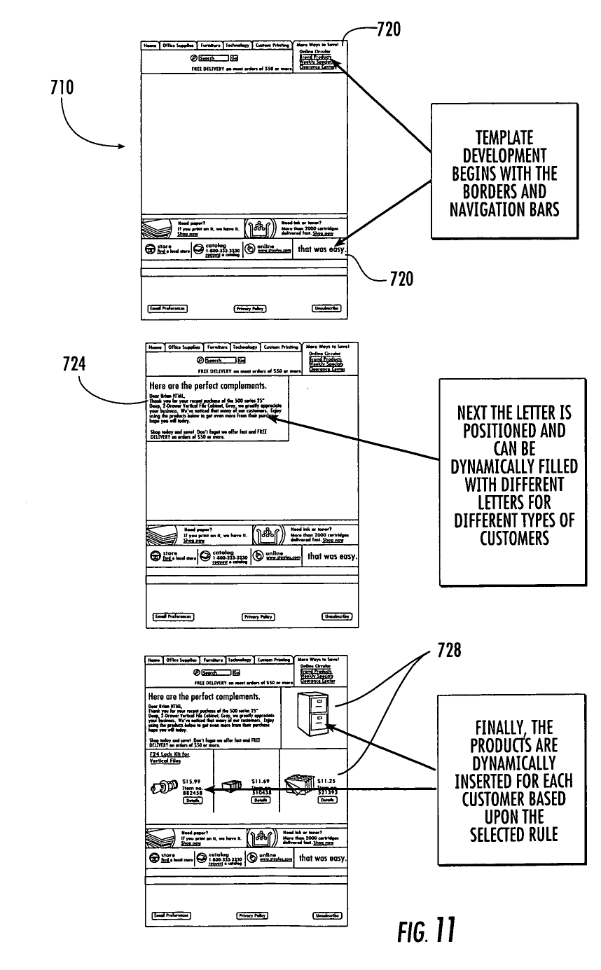

In this way, a great number of final campaign rules 420 can be developed. However, for each campaign 40, typically only one objective 410 and a corresponding rule are defined. This assures that the campaign results can be later measured against the objective 410. In this connection, FIG. 9 illustrates an example of a final campaign plan 710 also generated in Step 420. Campaign plan 710 contains the selected objectives 410 and corresponding rules, as well as information such as Campaign Theme, Mail Quantity, Template Due Date, Copy Due Date, Mail File Due Date, Category Definition Date, and Product Definition Date.

The system provides a template of the necessary information for completing a campaign. Most of these elements are provided by the client. Based on the client provided information, the system will determine the remaining campaign elements.

Once the above elements are determined, the delivery of a Brand Personalized campaign requires two types of data. These are the transaction data 20 (FIG. 1A), and the content data 36 (FIG. 1A). This data is processed against the final campaign rule(s) in a process 37 (FIG. 10), as follows:

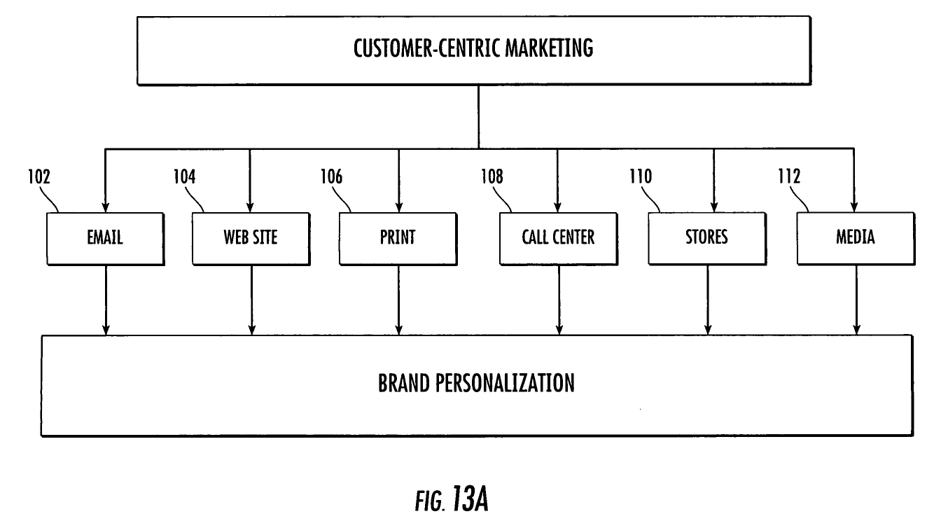

The selected rule is applied to the client's individual customers' transaction data to determine the offer to be received by each customer (see 910 in FIG. 12).

From the resulting file, the appropriate content (e.g. products, offers, etc . . . ) are identified.

Using the selected template, the content are used to populate each individual customer communication (e.g. email).

FIG. 10 illustrates delivery module 18 of FIG. 1A in greater detail. Based on final campaign rule 420, an email 620, website 630, call center 640, or wireless campaign 650 are executed. Campaigns directed to other sales channels such as print, store, and media channels can also be delivered as later explained. By way of example, an email campaign 620 will now be described wherein a plurality of personalized emails are generated for sending out to customers, based on final campaign rule 420. These personalized recommendations consist of a set of products, content and offers chosen specifically for each customer. These recommendations are stored in content database 36, and are added into each email as it is created and sent out. They may appear almost anywhere within an email template, and can have their own graphics, price information, offers, links, descriptions, and other attributes, which are stored within database 36. The recommendations are automatically inserted into the HTML or text of a message seamlessly by way of customized tags (not shown) placed within the template. The final output is an email consisting of properly formatted HTML (or text), containing the recommendations for the individual. The format is restricted to a specific number of fields or cells or locations that can contain customized content.

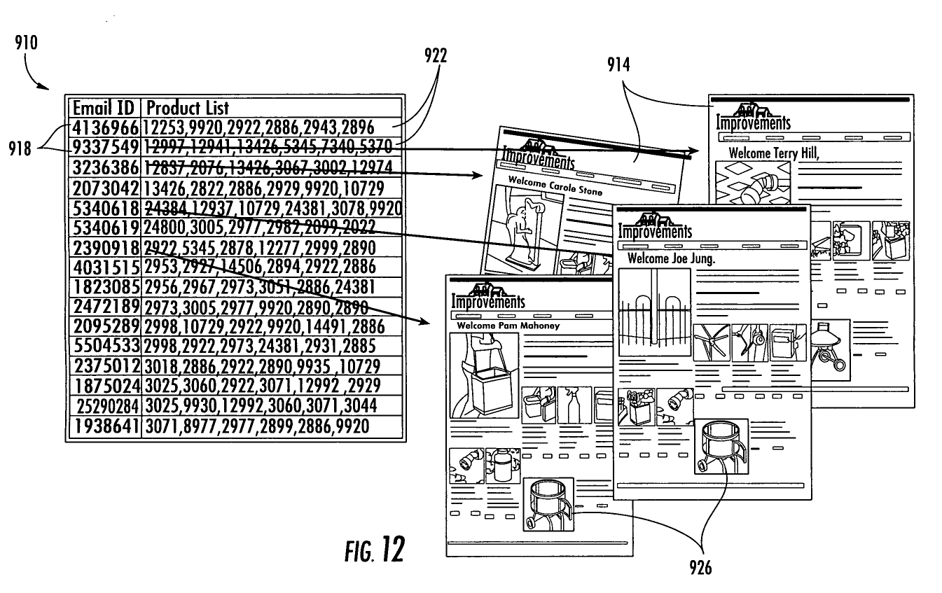

More specifically, template development begins with creating the borders and navigation bars 720, as shown in FIG. 11. Next, the letter 724 is positioned and can be dynamically filled with different letters for different types of customers. Finally, the products 728 are dynamically inserted for each customer based upon the final campaign rule 420. Examples of email types (not shown) used in template 710 include a first type, HTML Multipart, which contains full HTML. It also contains a text-only version, so that individuals who are not using an HTML-capable reader can view the text version. Another email type, AOL Multipart, contains HTML, and a text-only version formatted to AOL specifications. A third type, Text Only, contains a text-only email. It is used for individuals who are unable to handle MIME multipart formats. Advantageously, each text version of all three types contains a link that dynamically generates the HTML version of the email within the recipient's browser, with all personalized elements included. By this method, the recipient can view the full copy exactly as intended, with all personalized content included.

FIG. 12 illustrates an example of an email campaign matrix 910 utilized in generating a plurality of personalized emails 914. Matrix 910 includes an Email ID 918 which identifies each of the intended recipients. A product list 922 corresponds to each Email ID 918 and is based on final campaign rule 420. Each List 922 includes, for example, SKU numbers of products 926 to be featured in emails 914.

After the emails 914 are sent out, delivery module 18 of FIG. 1A provides for tracking and reporting of transaction data 670, browsing data 680 and campaign results 660, as shown in FIG. 10. Data 660, 670, 680 includes statistics such as Emails Sent, Email Bounces, Number of customers who view the HTML template, breakdown by Email Type (HTML, AOL, Text), Total number of product clicks, Number of individual clickers, Count each link or product was clicked, and Unsubscribe Counts. The foregoing data is tracked on an individual level. However, this information may be also summarized across dimensions such as by segment, email acquisition segment, or by email type.

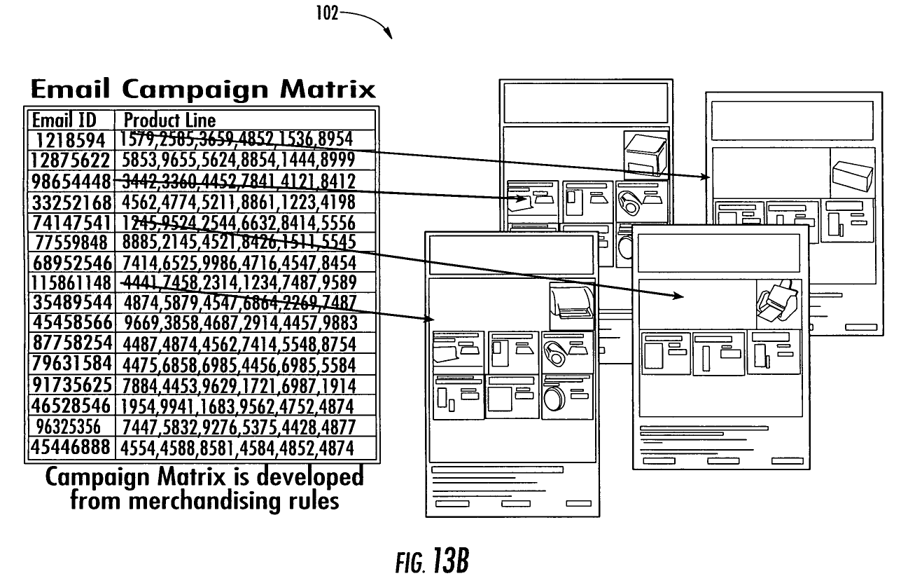

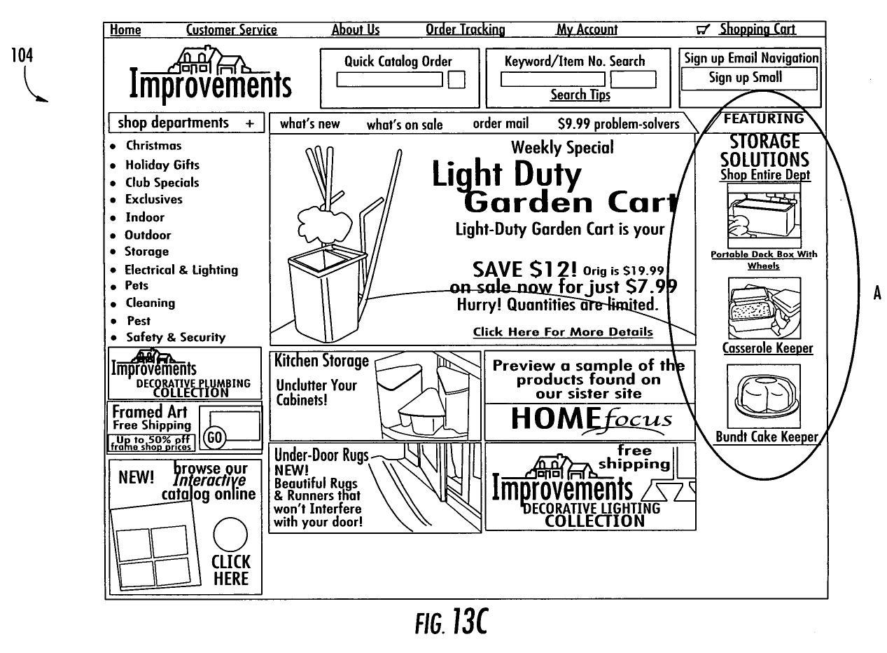

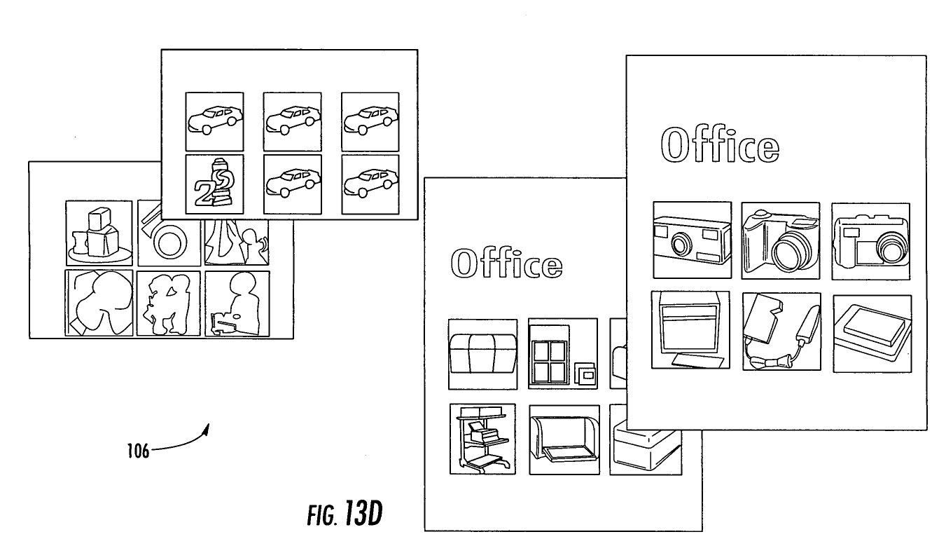

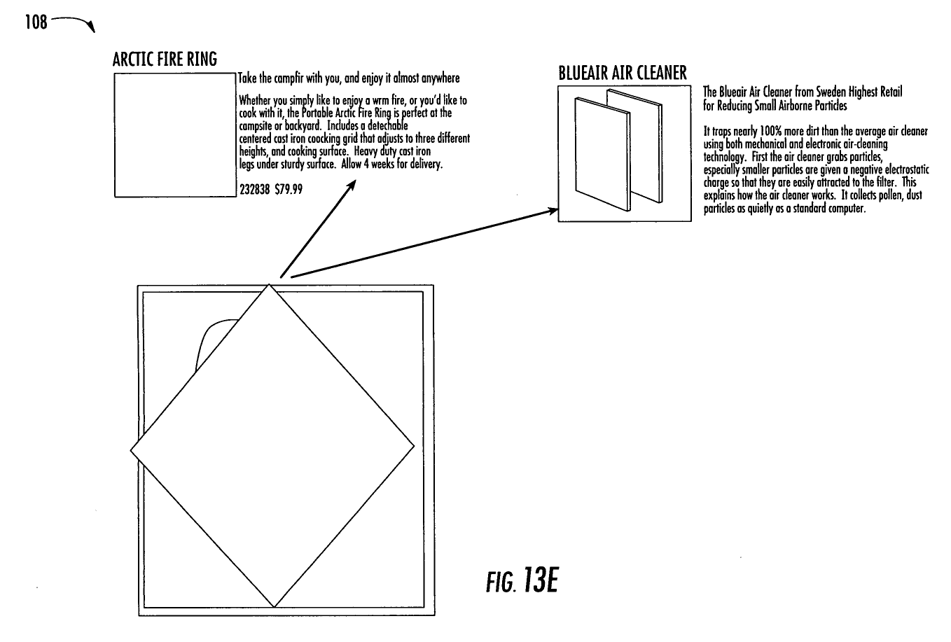

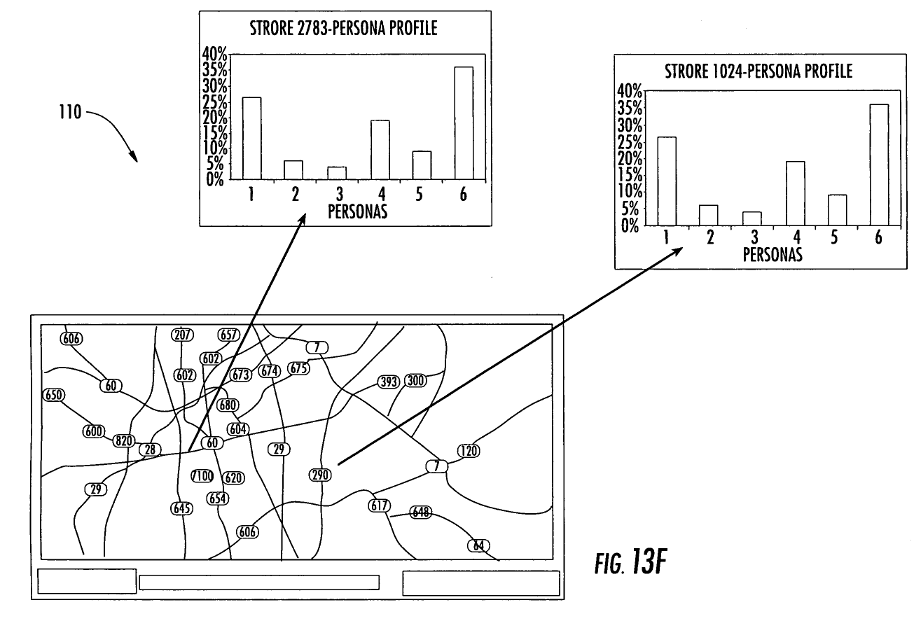

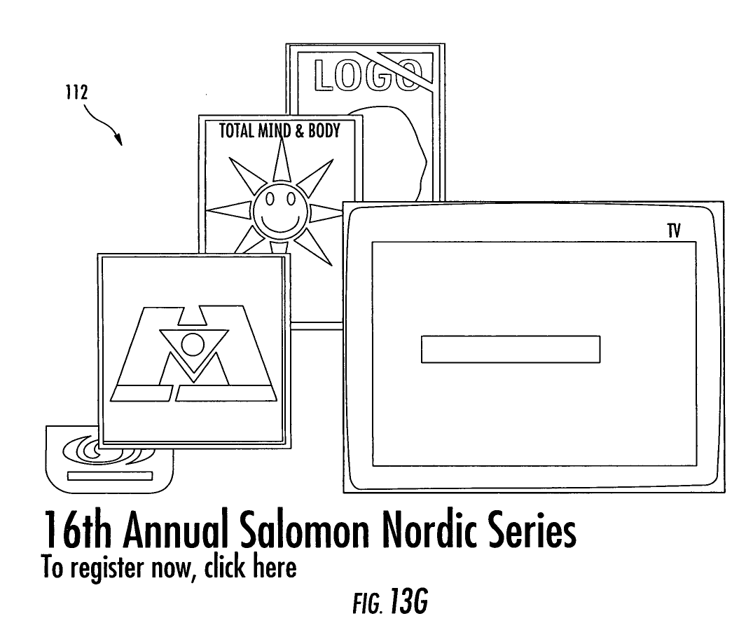

The same rules based approach used in the illustrative embodiment described above can also be applied to serving products and offers over multiple sales channels, as shown in FIG. 13A, including email 102, websites 104, print materials 106, call centers 108, stores 110 and media 112.

Email campaigns 102, as shown in FIG. 13B, can be organized into scheduled and event based. Scheduled campaigns include those sent on a regular basis and often have objectives such as up-sell, cross sell, replenishment and liquidation. Event based campaigns include those based upon actions by individual customers including welcome, sales add-on and campaigns sent to web site browsers. Each type of campaign employs personalization rules to make the communications as relevant as possible to the customer.

Web site campaigns 104 can also employ personalization rules. By designating specific areas of each page type to be personalized, such as area “A” in FIG. 13C, a plan can be developed to apply selected rules to specific areas of the web site. The rules applied to the web site are driven by either prior transaction data or click stream data for each visitor (or designated cookie).

Based upon the level of information available for each cookie, the software can determine which rule to apply and then present the appropriate products and/or offers in the specified locations. Objectives for web site rules can be as follows: for transaction driven rules, the objectives may include customized (User/SKU), up-sell (User/Category), or cross sell (User/Category). For click driven rules, the objectives can include customized (SKU/SKU), customized (Last Offer Clicked/SKU) or up-sell (Most Visited Category/Category).

Recent developments in printing, such as Xerox iGen, Kodak NextPress and HP Indigo, are making the cost of creating personalized print offers more cost-effective. These printers can take input from the personalization rules process to create print campaigns 106, as illustrated in FIG. 13D, that include products and offers personalized to the individual customer. This involves the development of an offer matrix and providing the appropriate high resolution images to a qualified printer. Such applications can include catalog covers, welcomes, sales add-ons or product replenishment. The use of catalog covers or post cards, for example, leverage the higher priced customization and have the potential for a strong return on investment.

A call center campaign 108, an illustrated embodiment of which is shown in FIG. 13E, also offers a strong opportunity to make a personalized offer to customers. The offer matrix produced by the personalization rules can be integrated with the legacy software used in the call center. In addition, customer service representative (CSR) training can be provided to facilitate representatives' understanding of how and why these offers are being made.

Traditionally, call center offers are based upon the item being ordered during the call. This approach has proven successful and should be continued. However, the personalization rules use past transaction history to expand the types of relevant offers available. For example, a customer could be reminded to purchase an attachment for a prior purchase not related to the current call. Also, a customer could be notified that the new colors for the shirt they ordered last year are now available. Examples of rules to apply to call centers are up-sell, cross sell, replenishment and liquidation.

For store campaigns 110, as shown in FIG. 13F, using the persona or segment level of the tiered profile for store analysis has many advantages. First, it is important to understand which types of customers shop in each store. Second, by analyzing the purchase behavior of each persona or segment, some of the variation in store merchandise sales might be explained. Third, stores demonstrating high concentrations of particular personas might be able to adjust their inventory or layout to better accommodate these customers. Finally, store advertising and promotions could be geared to the specific personas found in each store trade area.

To develop marketing communications that are relevant to customers, it is important to analyze advertising creative and media selection. As media campaigns 112, illustrated in FIG. 13G, become more targeted, companies can take advantage of their tiered profile to determine which customers are using selected media, and develop the creative for these media in a way that speaks to that specific customer or their persona. Opportunities for selecting targeted media include magazine, radio, cable and event marketing.

For example, “Persona 1” may be single males who listen to Rap, Hip Hop or Alternative radios stations and read Extreme Sports Magazines. “Persona 2” might be young couples with children listening to Top 40 or County stations and reading People or Money magazines. Appropriate creative development and media selection will improve relations with these customers.

Accordingly, the present invention allows marketers to address their customers in more relevant ways than ever before. The advance of the Internet, the diversity of choices available to consumers and the fragmentation of many media have made it an imperative to personalize communications to customers across all sales channels. The illustrated embodiments allow marketers to look at their customers using tiered profile that provides the relevant insight for each marketing communication. The invention provides a process for developing personalization rules that can be applied across all sales channels is provided, and the technology and affiliations to execute relevant marketing campaigns across all sales channels. The combination of the rules-based approach with the ability to deliver offers across multiple channels offers an easy solution for becoming true customer-centric marketers.

Although the illustrative embodiment of the method and apparatus is described herein as including certain “modules” and process steps, it should be appreciated by those skilled in the art that the functionality described herein may be divided up in to different modules and provided in different steps.

Further, it should be appreciated that while particular marketing and/or merchandizing analyses and particular objectives, it should be appreciated by those skilled in the art that other bases for analysis of customer behavior and other commercial objectives may be considered and implemented in developing findings according to the invention.

Among the additional applications of this invention are the use of the same rules based approach to send data driven notifications of special offers, product availability or new products sent via wireless technology to cell phones and PDAs.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A method for optimizing a business/marketing campaign, the method comprising the steps of:
providing, for a plurality of subscribers, transaction data relating to transactions performed via a plurality of sales channels during a predetermined time period;
analyzing transaction data of a first subscriber using a plurality of business analytics/metrics to calculate findings;
identifying, for said first subscriber, a plurality of campaign objectives as a function of said findings;
providing a plurality of campaign rules based on the transaction data of said plurality of subscribers;
selecting, from said plurality of campaign rules, campaign rules as a function of said campaign objectives; and
delivering, to at least one of said first subscriber's customers, a personalized communication as a function of said selected campaign rules and said at least one of said first subscriber's customers individual transaction history information.

2. The method of claim 1, wherein said sales channels including internet sites, retail stores, call centers, and catalog orders.

3. The method of claim 1, wherein said transaction data includes data relating to customers' purchases, said customer purchase data including at least one of (i) a type of item purchased; and (ii) the amount spent.

4. The method of claim 1, wherein said analytics are based upon of one of recency of order, order frequency, average order value, value contribution, relationship stage, and product purchasing patterns at the category, sub-category and SKU level.

5. The method of claim 1, wherein said findings include marketing findings selected from the group consisting of: Percent of one time buyers, Percent of three or more time buyers, Average order value (AOV) at 25%, AOV at 90%, AOV ratio, Percent of buyers at 0-6 months, Percent of buyers at 13+ months, Sales to order ratio low frequency/low AOV, Sales to order ratio high frequency/high AOV, Sales to order ratio low frequency/0-6 months, Sales to order ratio high frequency/0-6 months, Sales to order ratio low frequency/13+ months, and Sales to order ratio high frequency/13+ months.

6. The method of claim 1, wherein said findings include merchandising findings selected from the group consisting of: Category Sales Highest Deviation, Category Sales Lowest Deviation, Category Sales High/Low Ratio, Category Affinity Highest Percent, Category Affinity Lowest Percent, Category Affinity Average Percent, Sub-Category Low/Low-High/High Top 10 Overlap, Sub-Category Sales Ratio 1 to 20, Product Affinity Top 15 Average, Product Affinity 101-115 Average, and Product Affinity Ratio.

7. The method of claim 1, wherein said campaign objectives include 1) marketing objectives expressed in terms of one of average order value, frequency, recency, AOV by frequency, and recency by frequency; and 2) merchandising objectives expressed in terms of one of category, sub-category, SKU, category affinity, or SKU affinity.

8. The method of claim 1, wherein each campaign rule includes a rule type component that defines a statistical treatment of said transaction data, and said rule type is selected from one of Category, Multi-Category, Category Affinity, Product Affinity, Reactivation, Replenishment, Sales Add-On, Event Driven, Educational, Liquidation, Click Stream, or Multi-Channel rule types.

9. The method of claim 1, wherein each rule includes a customer definition component that defines customers purchases, and said customer definition is selected from one of Most Recent Purchase, Highest Total Amount, Highest Total Units, Highest Price, Date of Most Recent Purchase, Number of Purchases, or Average Order Value.

10. The method of claim 1 wherein each campaign rule includes a product definition component that defines selection of products to be offered to customers, and said product definition is selected from one of Overall Best Sellers, Category Best Sellers, Seasonal Items, New Products, Price Point, Brand, Overstocks, and High Margin.

11. A marketing optimization system, comprising:
a database containing transaction data for a plurality of subscribers, said transaction data relating to transactions made through a plurality of sales channels;
an analysis module for applying, to transaction data of a first subscriber, a plurality of analyses to calculate findings characterizing said data;
an objectives module for generating a plurality of objectives relating to the findings of said analyses;
a rules library containing rules based on said transaction data of said plurality of subscribers;
a rules module for selecting, from said rules library, a final campaign rule as a function of the generated objectives;
a delivery module for generating, for at least one of said first subscriber's customers, a personalized communication based on said final campaign rule and said at least one of said first subscriber's customers individual transaction information.

12. The system according to claim 11, wherein said communication is an email message that includes products, content and offers.

13. The system according to claim 12, wherein said transaction data of said plurality of said subscribers includes at least two years of at least one of clickstream/browsing data, purchase/sales data, zip codes, or addresses left behind by customers at a respective subscriber's website.

14. The system according to claim 11, wherein said analyses includes a marketing analysis of said first subscriber's transaction data as a function of one of recency of order, order frequency, or average order value.

15. The system according to claim 11, wherein said analyses includes a merchandising analysis of said first subscriber's transaction data as a function of one of value contribution, relationship stage, and product purchasing patterns at the category, sub-category and SKU level.

16. The system of claim 11, wherein each of said campaign rules includes components selected from (i) one of a first group, of components that defines a statistical treatment of said transaction data; (ii) one of a second group of component that defines customers purchases; and (iii) one of a third group of component that defines selection of products to be offered to customers.

17. The system of claim 16, wherein based on selection of the first, second, and third components, a first final campaign rule is determined.

18. The system of claim 17, wherein where: (i) the first component selected is category affinity, (ii) the second component selected is highest total units, and (iii) the third component selected is new products, then said first final campaign rule is:
a category affinity based upon an analysis calculating cross category potential, so that a buyer's category is selected based upon a category from which the buyer has purchased the most units, and so that the buyer receives two new products each from the category the buyer purchased and two highest affinity categories.

19. The system of claim 13, wherein after said email is sent out, said delivery module provides for tracking and reporting of the first subscriber's transaction data, browsing data, and campaign results.

20. The system of claim 19, wherein the data tracked and reported includes the numbers of emails sent, the numbers of email bounces, and a breakdown of email types.
